(19) United States
(12) Patent Application Publication
(10) Pub. No.: US 2006/0290645 A1
(43) Pub. Date: Dec. 28, 2006

(54) Electron emission display device and driving method thereof

(76) Inventor: Dong Hyup Jeon, Cheonan (KR)

Correspondence Address: CHRISTIE, PARKER & HALE, LLP, PO BOX 7068, PASADENA, CA, 91109-7068, US

(21) Appl. No.: 11/439,623

(22) Filed: May 23, 2006

(30) Foreign Application Priority Data
Jun. 16, 2005 (KR) 2005-51794

(51) Int. Cl. G09G 3/36

(52) U.S. Cl. 345/100

(57) ABSTRACT

Disclosed are an electron emission display device and a driving method thereof, which protect a drive circuit such as a display region or a data driver when the data driver operates erroneously. The display region receives a data signal from a data driver and a scan signal from a scan driver to display an image. A timing controller provides a drive signal to the data driver and the scan driver to drive the data driver and the scan driver. A data sensor senses whether the data driver is malfunctioning. A power supply unit supplies an electric drive source to the display region, the data driver, the scan driver, the timing controller, and the data sensor. In case of data driver malfunction, the data sensor is capable of preventing the supply of power to various parts of the device by disabling the power supply unit.

### CROSS-REFERENCE TO RELATED APPLICATION

This application claims priority to and the benefit of Korean Patent Application No. 10-2005-0051794, filed on Jun. 16, 2005, in the Korean Intellectual Property Office, the entire content of which is incorporated herein by reference.

### BACKGROUND

1. Field of the Invention

The present invention relates to an electron emission display device and a driving method thereof. More particularly, the present invention relates to an electron emission display device and a driving method thereof, which prevents a panel from being damaged when a scan signal stops.

2. Discussion of Related Art

Lightweight and thin flat panel displays have been used either as a display device of a portable information terminal such as a personal computer, a portable telephone, or a PDA or as a monitor for other kinds of information devices. LCD using a liquid crystal panel, organic light emitting display device using an organic light emitting diode, and PDP using a plasma panel are examples of such flat panel displays.

Flat panel displays are classified into an active matrix type and a passive matrix type according to their construction, and also into a memory drive type and a non-memory drive type according to their light emitting theory. In general, the active matrix type may correspond to the memory drive type, and the passive matrix type may correspond to the non-memory drive type. The active matrix type and the memory drive type displays emit light in frames. In contrast, the passive matrix type and the non-memory drive type displays emit light in lines.

In flat panel displays being commonly used, thin film transistor liquid crystal display (TFT-LCD) and a newly developed active matrix organic light emitting diode (AMOLED) display device are of the active matrix type. In contrast, an electron emission display (EED) device is a new display device of the passive matrix type. Unlike other flat panel displays, the electron emission display device is of the non-memory drive type and uses a line scan type that emits light only when a certain line among horizontal lines is selected while sequentially selecting the horizontal lines. That is, the electron emission display device drives the horizontal lines with a constant duty ratio.

FIG. 1 is a block diagram showing a configuration of a conventional electron emission display device. With reference to FIG. 1, the conventional electron emission display device includes a display region 10, a data driver 20, a scan driver 30, a timing controller 40, and a power supply unit 50.

The display region 10 includes pixels 11 provided at areas where the cathode electrodes C1, C2 . . . Cm and the gate electrodes G1, G2 . . . Gn cross over. Each of the pixels 11 includes an electron emission portion. In the electron emission portion, electrons emitted from the cathode electrode collide with the anode electrode and cause a fluorescent substance to emit light in order to display an image. The gradation of the displayed image is varied according to a value of a digital image signal. In order to adjust the displayed image, varied according to the digital image signal value, a pulse width modulation (PWM) or a pulse amplitude modulation (PAM) may be used.

The data driver 20 generates a data signal using the image signal. The data driver 20 is associated with the cathode electrodes C1, C2 . . . Cm, and causes the data signal to be provided to the display region 10, so that the display region 10 emits light corresponding to the data signal.

The scan driver 30 is connected to the gate electrodes G1, G2 . . . Gn. The scan driver 30 generates and provides a scan signal to the display region 10, so that the display region 10 sequentially emits light in horizontal lines to display an image on the entire screen. This allows the cost of the circuit and power consumption to be reduced.

The timing controller 40 provides a data driver control signal and a scan driver control signal respectively to the data driver 20 and the scan driver 30 in order to control them.

The power supply unit 50 supplies a power source to the display region 10, the data driver 20, the scan driver 30, and the timing controller 40 to drive them.

The conventional electron emission display device, having the construction mentioned above, uses a line scan method. Accordingly, if a circuit is out of order due to external shock or noise, thereby the data driver malfunctions, and the data signal from the data driver 20 cannot be provided to the desired line. As a substantially constant electric current similar to DC flows from the data driver 20 to a line, the panel may be damaged and the circuit may heat up or be damaged. That is, after the circuit sequentially heats a horizontal line in a constant duty, if the scan operation stops, a pulse similar to DC instead of a pulse having a constant duty is applied to the circuit. Accordingly, an emission current is generated at only the line receiving the current, thereby significantly damaging a cathode electrode of the panel or reducing its life. Furthermore, an electric current greater than a rating value of the circuit flows because of the data signal, thereby heating and damaging the drive circuit.

### SUMMARY OF THE INVENTION

Accordingly, it is an aspect of the present invention to provide an electron emission display device and a driving method thereof, which protect a drive circuit such as a display region or a data driver when the data driver operates erroneously.

A first aspect of the present invention provides an electron emission display device comprising a display region for receiving a data signal and a scan signal to display an image, a data driver for providing a data signal to the display region, a scan driver for providing a scan signal to the display region, a timing controller for providing a drive signal to the data driver and the scan driver to drive the data driver and the scan driver, a data sensor for sensing that the data driver is malfunctioning, and a power supply unit for supplying an electric drive power to the display region, the data driver, the scan driver, the timing controller, and the data sensor.

A second aspect of the present invention provides a method for driving an electron emission display device comprising generating a control signal corresponding to a shift signal, and judging whether the data driver is malfunctioning according to the control signal.

### BRIEF DESCRIPTION OF THE DRAWINGS

These and other aspects and features of the invention will become apparent and more readily appreciated from the following description of the exemplary embodiments, taken in conjunction with the accompanying drawings of which:

FIG. 1 is a block diagram showing a configuration of a conventional electron emission display device;

FIG. 2 is a block diagram showing a configuration of an electron emission display device according to an embodiment of the present invention;

FIG. 3 is a perspective view showing a display region of the electron emission display device of FIG. 2;

FIG. 4 is a cross-sectional view of the display region shown in FIG. 2 taken along the line A-A′;

FIG. 6 is a timing diagram showing inputs to a data driver of the electron emission display device shown in FIG. 2;

FIG. 7 is a circuit diagram of an exemplary Logic IC of a data sensor shown in FIG. 2;

FIG. 8 is a timing diagram showing input and output signals of the Logic IC shown in FIG. 7;

FIGS. 9A and 9B are timing diagrams showing input and output waveform characteristics of a data sensor according to an embodiment of the present invention;

FIG. 10 is a circuit diagram of a first example of a connection state of the data sensor according to an embodiment of the present invention;

FIG. 11 is a timing diagram showing operation of the data sensor shown in FIG. 10; and

FIG. 12 is a circuit diagram of a second example of a connection state of the data sensor according to an embodiment of the present invention.

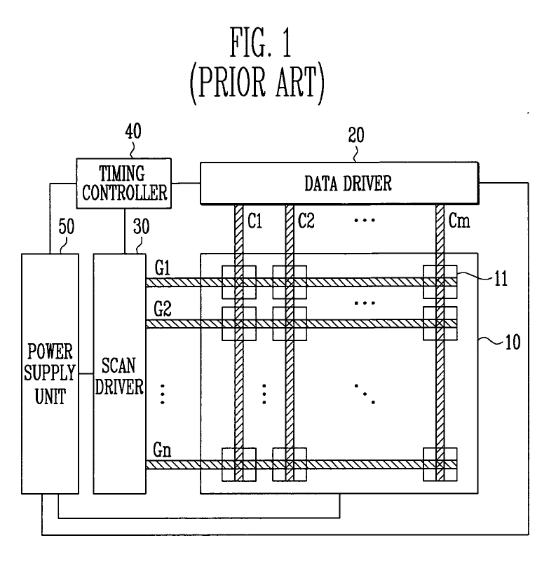

### DETAILED DESCRIPTION

Hereinafter, exemplary embodiments of the present invention will be described with reference to the accompanying drawings. Here, when one element is described as being connected to another element, the element may be directly connected to another element or indirectly connected to another element via one or more other elements. Terminals of circuit components and input signals to these terminals may be both referenced by the same reference label. Further, some nonessential elements are omitted for clarity. Also, like reference numerals and labels refer to like elements throughout.

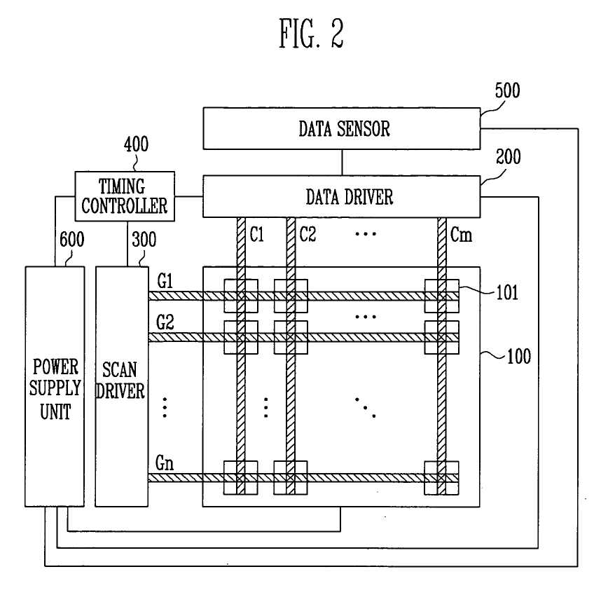

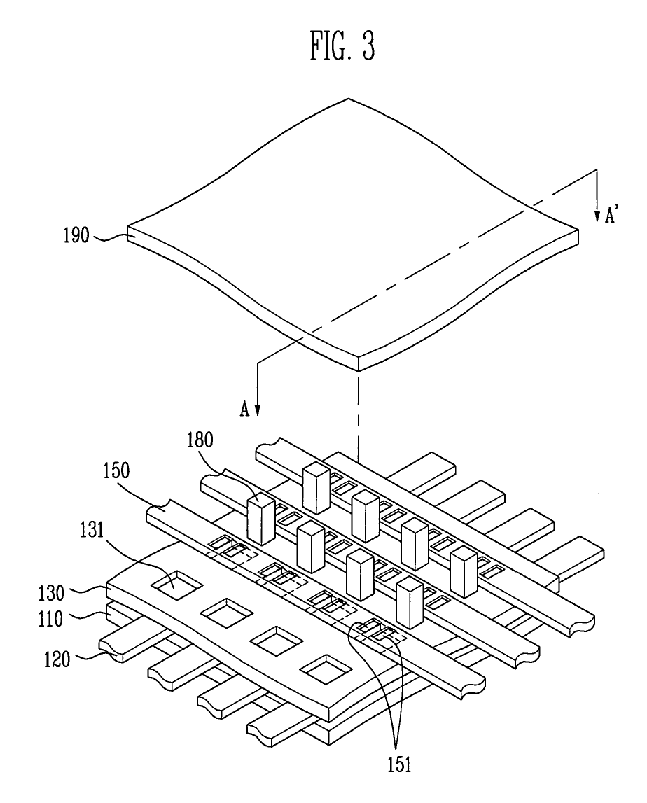

FIG. 2 is a block diagram showing a configuration of an electron emission display device according to an embodiment of the present invention. FIG. 3 is a perspective view showing a display region of the electron emission display device of FIG. 2. With reference to FIG. 2 and FIG. 3, the electron emission display device includes a display region 100, a data driver 200, a scan driver 300, a timing controller 400, a data sensor 500, and a power supply unit 600.

The display region 100 includes pixels 101. In the display region 100, a plurality of cathode electrodes C1, C2 . . . Cm are arranged in a row direction and extend in a column direction, a plurality of gate electrodes G1, G2 . . . Gn are arranged in a column direction and extend in a row direction, and electron emission sources are provided where the cathode electrodes C1, C2 . . . Cm and the gate electrodes G1, G2 . . . Gn cross over one another. Alternatively, the cathode electrodes C1, C2 . . . Cm and the gate electrodes G1, G2 . . . Gn may be arranged in column and row directions, respectively. Hereinafter, it is assumed that the cathode electrodes C1, C2 . . . Cm are arranged in the row direction, and the gate electrodes G1, G2 . . . Gn are arranged in the column direction.

The data driver 200 provides a serially input video data signal to the display region 100 in parallel using a shift signal. The data driver 200 is connected to the cathode electrodes C1, C2 . . . Cm, and provides the data signal to the cathode electrodes C1, C2 . . . Cm, so that a gradation is expressed using the on/off time ratio for each of the pixels 101 formed where the cathode electrodes C1, C2 . . . Cm and the gate electrodes G1, G2 . . . Gn cross over.

The scan driver 300 is connected to the gate electrodes G1, G2 . . . Gn, and selects one of the gate electrodes G1, G2 . . . Gn. The scan driver 300 provides a scan signal to pixels 101 connected to the gate electrodes G, G2 . . . Gn.

The timing controller 400 receives an image signal and generates control signals for driving the data driver 200 and the scan driver 300. The control signal is provided to the data driver 200 and the scan driver 300. In detail, the timing controller 400 generates a first control signal for driving the data driver 200 and a second control signal for driving the scan driver 300. The second control signal may sequentially select horizontal lines for driving the scan driver 300.

The data sensor 500 senses a shift signal outputted from the data driver 200. When the sensed shift signal does not maintain a normal waveform, the data sensor 500 stops the operation of the data driver 200, or the power supply unit 600, to protect the display region 100 and the data driver 200. When the operation of the data driver 200 or the power supply unit 600 stops, the display region 100 does not express. The data sensor 500 includes a Logic IC, and calculates the shift signal and a signal, which may be predetermined, in order to control the operation of the data driver 200 or the power supply unit 600.

The power supply unit 600 functions to supply the necessary power to the respective constitutional elements of the display device. That is, the power supply unit 600 provides an anode voltage to the display region 100. The power supply unit 600 delivers an electric drive power to the data driver 200, the scan driver 300, the timing controller 400, and the data sensor 500.

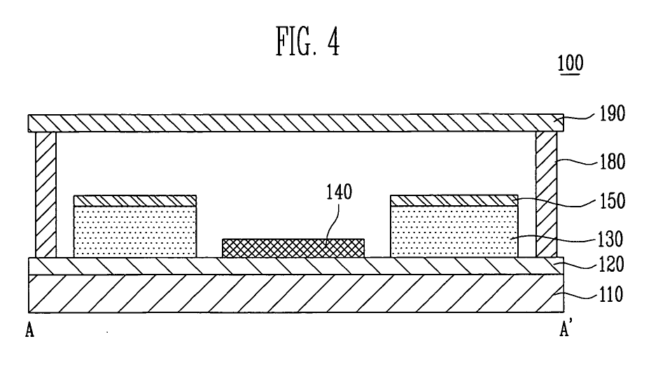

FIG. 3 is a perspective view showing the display region 100 of the electron emission display device of FIG. 2. FIG. 4 is a cross-sectional view of the display region 100 shown in FIG. 3 taken along the line A-A′. With reference to FIGS. 3 and 4, the electron emission display device includes a lower substrate 110, an upper substrate 190, and spacers 180. Cathode electrodes 120, an insulation layer 130, and gate electrodes 150 are sequentially formed on the lower substrate 110. An electron emission portion 140 is also formed on the lower substrate 110. A front substrate, an anode electrode, and a fluorescent film are formed on the upper substrate 190.

At least one cathode electrode 120 is formed on the lower substrate 110 in a stripe pattern. The insulation layer 130 is formed over the cathode electrodes 120. A plurality of first grooves or openings 131 are formed in the insulation layer 130 to expose a part of the cathode electrodes 120. The gate electrodes 150 are formed over the insulation layer 130. A plurality of second grooves or openings 151 are formed at each of the gate electrodes 150 over the first grooves 131. Each of the second grooves 151 has a substantially constant size. The electron emission portion 140 is formed over the cathode electrodes 120 in an area corresponding to the first groove 131 and the second grooves 151.

A glass or a silicon material may be used for the lower substrate 110. When the electron emission portion 140 is formed from a paste using rear exposure, then a transparent substrate such as a glass substrate is used for the lower substrate 110.

The cathode electrode 120 provides a data signal from the data driver 200 (FIG. 2) to the electron emission portion 140. The gate electrodes 150 provide a scan signal from the scan driver 300 (FIG. 2) to the electron emission portion 140. An indium tin oxide (ITO) material may be used to form the cathode electrode 120.

The insulation layer 130 formed over the cathode electrode 120 electrically insulates the cathode electrode 120 and the gate electrode 150 from each other.

The gate electrodes 150 are disposed on the insulation layer 130 in a predetermined pattern, for example a stripe pattern along a direction crossing the direction of the stripes of the cathode electrodes 120. The gate electrodes 150 provide a data signal from the data driver 200 or a scan signal from the scan driver 300 to its corresponding pixels 101. The gate electrodes 150 are made of a highly conductive metal, for example, gold (Au), silver (Ag), platinum (Pt), aluminum (Al), chromium (Cr), or an alloy thereof.

The electron emission portion 140 is electrically connected to the cathode electrode 120 and is exposed through the first groove 131 of the insulation 130. The electron emission portion 140 is made of one or more materials that emit electrons when an electric field is applied to them. These materials include carbon based materials, materials having a nanometric size, carbon nano tubes, graphite, graphite nano fibers, carbon on diamond material, C₆₀, silicon nano fiber, and a combination thereof.

The upper substrate 190 includes the fluorescent film. When electrons collide with the fluorescent film, the upper substrate 190 emits light. The upper substrate 190 includes the anode electrode that causes the electrons emitted from the electron emission portion 140 to collide with the upper substrate 190.

The spacers 180 provide a predetermined distance between the lower substrate 110 and the upper substrate 190.

FIG. 5 is a block diagram of the data driver of the electron emission display device shown in FIG. 2. Referring to FIG. 5, the data driver 200 includes a shift register 210, a sampling latch 220, a holding latch 230, and a digital/analog (D/A) converter 240.

The shift register 210 receives an input signal DDIN and clock DCLK, and generates intermediate shift signals at predetermined time intervals. The intermediate shift signals are obtained by shifting the input signal DDIN by the clock DCLK. After continually shifting the intermediate shift signals, a final shift signal DDOUT is outputted to an output terminal. If the shift register 210 malfunctions or becomes out of order, it does not generate the intermediate shift signals, so that the final shift signal DDOUT becomes a low or a high level signal instead of being the shifted input signal DDIN.

The sampling latch 220 includes a number of data latches, for example Data Latch 1 . . . Data Latch 32, that are coupled together in series and generate parallel outputs. The sampling latch 220 outputs the serially input video data signal in parallel in response to the shift signal.

The holding latch 230 includes a latch section 231 and a counter 232. The latch section 231 includes a number of comparator and latches, for example Comparator and Latch 1 . . . Comparator and Latch 32, coupled together and each receiving an output of one of the data latches of the sampling latch 220 and outputting signals in parallel to the counter 232. The latch section 231 receives the video data signal from the sampling latch 220, and the counter 232 outputs the video data signal received by the latch section 231.

The counter 232 includes a number of logic units coupled together and each receiving an output of one of the comparator and latches of the latch section 231 and outputting signals in parallel to a number of NOR gates. The counter 232 also includes a blank signal input terminal. When the counter 232 receives a blank signal Blank through the blank signal input terminal, it resets the holding latch 230 to prevent the signal of the holding latch 230 from being outputted. This prevents a data signal from being outputted to a data line.

The D/A converter 240 converts the video data signal outputted from the holding latch 230 into an analog data signal, and provides the analog data signal to the display region 100.

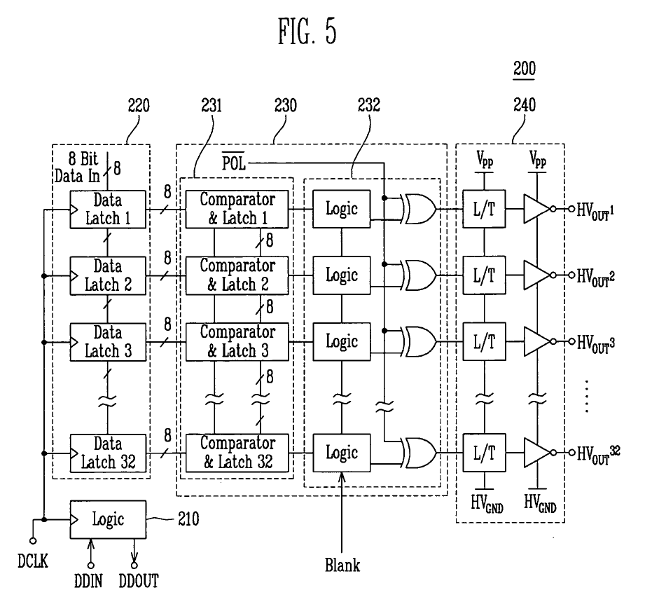

FIG. 6 is a timing diagram showing input and output signals of the shift register shown in FIG. 5. With reference to FIG. 6, reference label DCLK represents the clock signal inputted to the shift register 210 of the data driver 200. The clock signal DCLK controls the sampling latch 220 to output the serially input video data signal in parallel. The reference label DDIN represents the signal that is inputted to the shift register 210 to generate a series of intermediate shift signals sr1, sr2, sr3 . . . srn in synchronization with the clock signal DCLK. Reference label DBLK represents a blank signal input to the shift register 210 of FIG. 5. In order to prevent input data from being provided to two lines due to a waveform delay at the rising and falling times of the clock signal DCLK in the shift register 210, the blank signal DBLK is used to cause a blank between the two lines for a predetermined time. That is, when the blank signal DBLK is at a high level, all parallel outputs of the sampling latch 220 are turned off. The reference label DDOUT denotes the serial data output signal.

That is, the DDIN signal is inputted to the shift register 210 and is shifted by the DCLK, and is outputted as the shift signal DDOUT from the shift register 210. A pulse width of the DDOUT signal is substantially identical with the period of the DCLK.

As described above, during normal operation, a pulse should be outputted to a terminal DDOUT for a predetermined time period. If operation of the data driver 200 stops, a high or low signal instead of a signal in a form of a pulse is outputted at the terminal DDOUT. Depending on circumstances, this can cause a critical defect in the circuit and the display region 100.

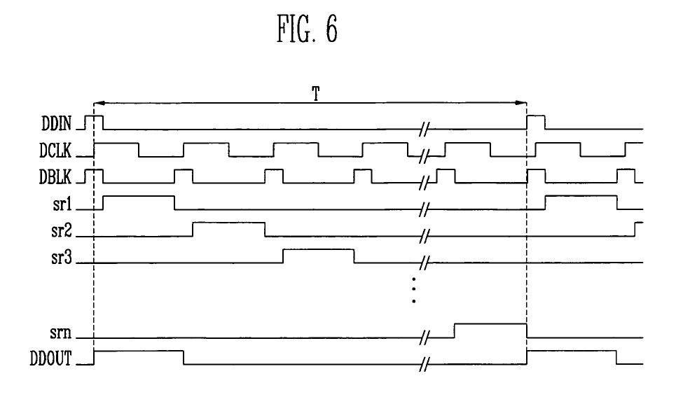

FIG. 7 is a view showing an example of a Logic IC of the data sensor shown in FIG. 2. FIG. 8 is a timing diagram showing input and output signals of the Logic IC shown in FIG. 7. Referring to FIGS. 7 and 8, the data sensor 500 can sense whether or not the shift register 210 of the data driver 200 is generating a periodic pulse waveform. When a pulse waveform is not generated within a certain amount of time, the data sensor 500 determines that the operation of the data driver 200 has stopped. The data sensor 500 may include a Logic IC having a monostable multivibrator function.

The Logic IC includes an RCx terminal, a Cx terminal, a T1 terminal, a /CLR terminal, a Q terminal, and a /Q terminal. The RCx terminal and the Cx terminal connect the Logic IC to a resistor Rt and a capacitor Ct, which are used as variables to determine an output pulse width. The T1 terminal is a trigger input terminal for input of a pulse or signal. The /CLR terminal is a terminal for resetting the output. The Q terminal and the /Q terminal are output terminals for outputting the output pulse or signal.

In the case where a high signal is inputted to the /CLR terminal of the Logic IC, when a signal changing from a low level to a high level is inputted to the T1 terminal, an output pulse is outputted to the output terminals Q and /Q. The duration or width Tp of the output pulse depends on the values of the resistor Rt and the capacitor Ct connected to the RCx and Cx terminals.

When a pulse is inputted to the Logic IC through the T1 terminal, the pulse is outputted through an output terminal Q or /Q when the input pulse of T1 changes from a low level to a high level. The width Tp of the output pulse is determined by the values of Rt and Ct. Typical monostable multivibrator Logic ICs have characteristic of Tp=k×Rt×Ct, where k is a constant which has a value of 0<k<1 and varies according to the particular Logic IC.

For example, in the case that the Logic IC includes the 74HC/HCT4538 monostable multivibrator by Philips Ltd., the Logic IC has a characteristic of Tp=0.7×Rt×Ct , with the units of each parameter given as Tp in ns, Rt in kΩ, and Ct in pF. In the case of DM74LS123 by Fairchild Ltd., the Logic IC has a characteristic of Tp=0.37×Rt×Ct with the parameters expressed in the same units of Tp in ns, Rt in kΩ, and Ct in pF. During the period Tp, the voltage at the RCx terminal drops to a first reference voltage Vref1 and subsequently rises to a second reference voltage Vref2.

Input of a first input pulse through the input terminal T1 can generate a first output pulse through the output terminal Q. If while the first output pulse is being generated through the output terminal Q, another pulse is inputted to the Logic IC through the T1 terminal, the output pulse is continued from the input time of the second pulse by the amount Tp. If a reset signal is inputted through the /CLR terminal, the Logic IC resets the output regardless of the input at T1. In the embodiment being described, a low reset signal input through the /CLR terminal resets the output.

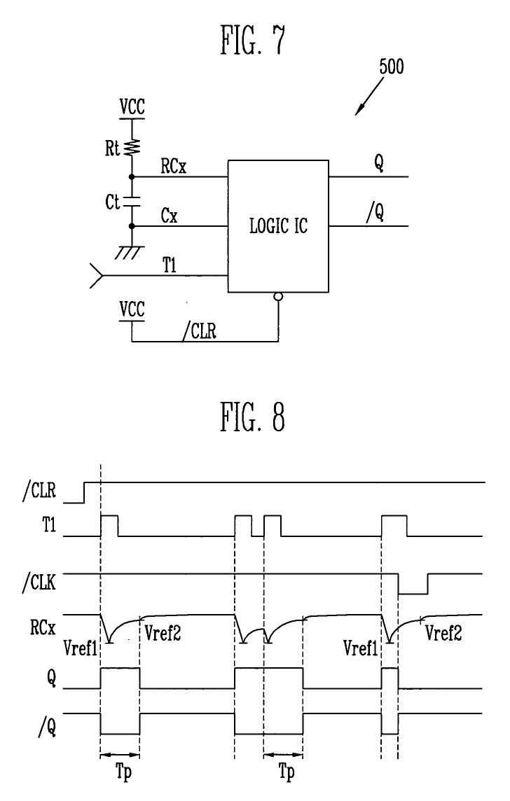

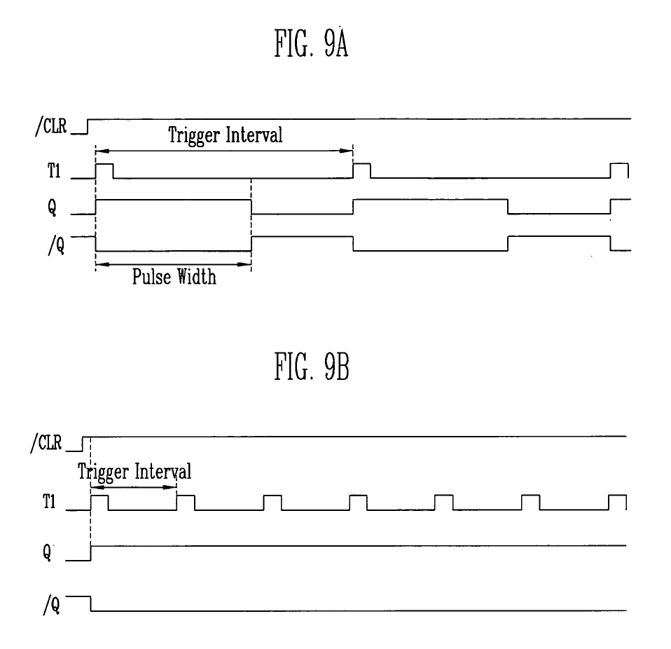

FIGS. 9A and 9B are timing diagrams showing input and output waveform characteristics of a data sensor according to an embodiment of the present invention. Referring to FIGS. 9A and 9B, when a trigger signal is inputted to the data sensor, the data sensor outputs a pulse or signal having a substantially constant pulse width of about k×Rt× Ct through an output terminal.

FIG. 9A shows a case where a Trigger Interval between two consecutive trigger signals inputted to the T1 terminal is greater than a Pulse Width of the output signal at Q or /Q. Namely, after the Logic IC generates the output pulse, it stays at a reference level until a next trigger signal is inputted at T1 to the Logic IC, at which time the Logic IC generates another output pulse at Q or /Q. FIG. 9B shows a case where the Trigger Interval between two consecutive trigger signals inputted to the T1 terminal is less than the Pulse Width of the output signal at Q or /Q. When the trigger signal is inputted, the output level at Q or /Q changes and the Pulse Width is maintained for a predetermined time period. When a next trigger signal is inputted prior to a time period corresponding to the Pulse Width, the output level at Q or /Q will remain at its previous level for the predetermined time period. Consequently, when the trigger signal continues to be inputted at Trigger Intervals less than the Pulse Width, the output signal continues to maintain its level to generate the pulse. The width of the pulse generated in this case is greater than the Pulse Width.

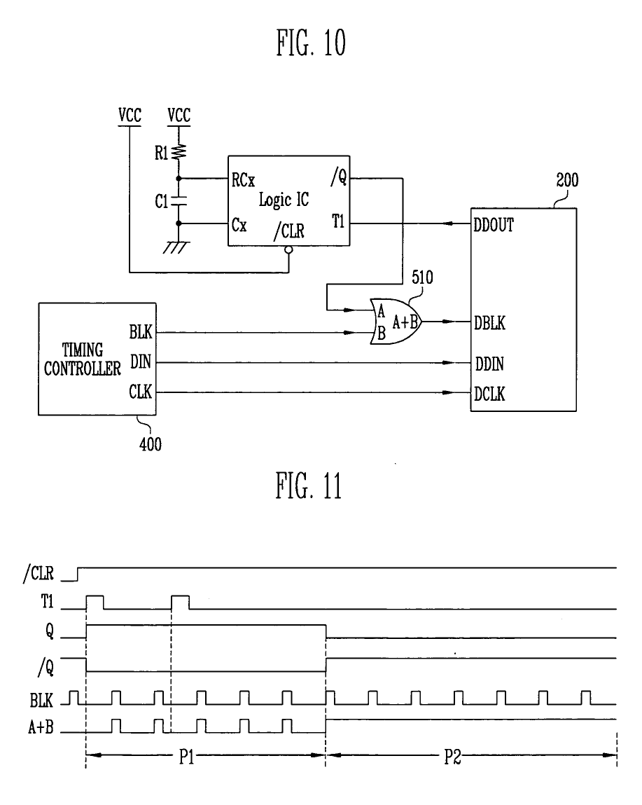

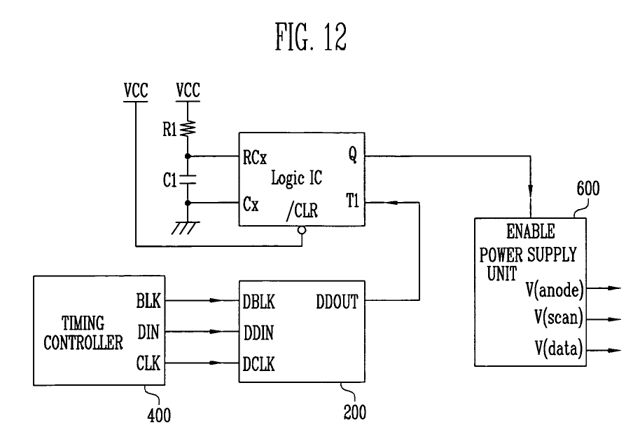

FIG. 10 is a circuit diagram of a first example of a connection state of the data sensor according to an embodiment of the present invention. FIG. 11 is a timing diagram showing the operation of the data sensor shown in FIG. 10. As shown in FIGS. 10 and 11, the T1 terminal of the Logic IC of the data sensor 500 is connected to a DDOUT terminal of the data driver 200, and the /Q terminal of the Logic IC is connected to one of the input terminals A of an OR gate 510. Further, a blank signal output terminal BLK of the timing controller 400 is connected to the other input terminal B of the OR gate 510. The OR gate 510 outputs an ORed signal A+B to the blank signal terminal DBLK of the shift register 210 in the data driver 200.

Accordingly, during a period P1, when the shift register 210 of the data driver 200 operates normally, because the output /Q of the Logic IC has a low level, the BLK signal of the timing controller 400 is provided through the OR gate 510 to the blank signal terminal DBLK of the data driver 200 to control the data driver 200. In contrast, during a period P2, when the operation of the shift register 210 of the data driver 200 stops, the output /Q of the Logic IC becomes a high level, and a high level is inputted to the blank signal terminal DBLK by the OR gate 510 regardless of the level of the BLK signal of the timing controller 400. Accordingly, the data driver 200 is reset, causing all outputs to become blank.

In the illustrated embodiments, the circuit components and the circuit arrangement scheme may be suitably adjusted according to the configuration of the display region and input/output signal characteristics of the data driver. For example, in a case where a DBLK signal characteristic of the data driver is opposite to that of the embodiment described, since an inverted signal is necessary, a NOR gate may be used in place of the OR gate 510.

FIG. 12 is a circuit diagram showing a second example of a connection state of the data sensor according to an embodiment of the present invention. Referring to FIG. 12, the T1 terminal of the Logic IC is connected to the DDOUT terminal of the data driver 200, and the Q terminal of the Logic IC is connected to an ENABLE terminal of the power supply unit 600. Moreover, the blank signal terminal BLK of the timing controller 400 is connected to the blank signal terminal DBLK of the data driver 200.

When the data driver 200 operates normally, since the output of the Q terminal of the Logic IC is at a high level, the operation of the power supply unit 600 is controlled in a normal state. In contrast, when the operation of the data driver 200 stops, since the output of the Q terminal of the Logic IC becomes a low level, a main output of the power supply unit 600 is intercepted to prevent heating of the data driver 200 or an abnormal emission of the display region 100.

Upon controlling the power supply unit 600 by the ENABLE signal, a main control power supply may control either only a data power supply V(data) or concurrently control an anode source V(anode) having the data power supply V(data) and a scan power supply V(scan).

In the electron emission display device and the driving method thereof according to the present invention, when the scan operation stops, a logic circuit controls either the output of the scan driver or the power supply unit in order to protect the drive circuit as well as the display panel.

Although exemplary embodiments of the present invention have been shown and described, it would be appreciated by those skilled in the art that changes might be made in this embodiment without departing from the principles and spirit of the invention, the scope of which is defined in the claims and their equivalents.

What is claimed is:

1. An electron emission display device comprising:
a display region for receiving a data signal and a scan signal to display an image;
a data driver for providing the data signal to the display region;
a scan driver for providing the scan signal to the display region;
a timing controller for providing a drive signal to the data driver and the scan driver to drive the data driver and the scan driver;
a data sensor for sensing a malfunctionthe data driver; and
a power supply unit for supplying power to the display region, the data driver, the scan driver, the timing controller, and the data sensor.

2. The electron emission display device according to claim 1, wherein the timing controller stops at least one of the data driver and the power supply unit when the data driver malfunctions.

3. The electron emission display device according to claim 1, wherein the data driver comprises:
a shift register for outputting a shift signal;
a holding latch for outputting a serially input video data signal in parallel; and
a digital/analog converter for converting the video data signal into an analog signal.

4. The electron emission display device according to claim 3, wherein the data sensor receives the shift signal and determines whether the data driver is out of order based on the received shift signal.

5. The electron emission display device according to claim 3, wherein the data sensor determines that the data driver is out of order when the received shift signal remains at a voltage level for a time greater than a predetermined time.

6. The electron emission display device according to claim 3, wherein the data sensor comprises:
an integrated circuit for outputting a control signal corresponding to the scan signal; and
a calculator for calculating an output of the integrated circuit and an output of the timing controller.

7. The electron emission display device according to claim 1, wherein the timing controller prevents operation of the display device if the data sensor senses that the data driver is malfunctioning.

8. A method for driving an electron emission display device comprising:
generating a shift signal;
generating a control signal corresponding to the shift signal; and
preventing operation of the display device according to the control signal.

9. The method of claim 8,
wherein the display device comprises a data driver for driving data lines coupled to the data driver, and
wherein said preventing operation of the display device comprises preventing the data driver from driving the data lines.

10. The method of claim 8,
wherein the display device comprises a data driver for driving data lines coupled to the data driver, a scan driver for driving scan lines coupled to the scan driver, and a power supply unit for supplying power to the data driver and the scan driver, and
wherein said preventing operation of the display device comprises preventing the supply of power to at least one of the data driver or the scan driver.

11. The method of claim 8, further comprising:
serially providing input data signals to a data driver;
generating parallel data signals by the data driver for driving data lines coupled to the data driver; and
serially generating the shift signal from the data driver.

12. A method for driving an electron emission display device, the display device comprising a display region comprising data lines and scan lines, a data driver coupled to the data lines, a scan driver coupled to the scan lines, a timing controller for generating control signals for driving the data driver and the scan driver, a data sensor coupled to the data driver, and a power supply unit for supplying power to the data driver, the scan driver, the timing controller, and the data sensor, the method comprising:
providing scan signals from the scan driver to the scan lines;
serially providing input data signals to the data driver;
generating parallel data signals by the data driver for driving the data lines;
generating a serial shift signal from the data driver, the shift signal having a shift signal pulse width and a shift signal period;
sensing the shift signal by the data sensor;
generating a control signal by the data sensor, the control signal having a control signal pulse width; and
preventing operation of the display device according to the control signal pulse width.

13. The method of claim 12, wherein said preventing operation of the display device comprises preventing the data driver from driving the data lines.

14. The method of claim 12, wherein said preventing operation of the display device comprises preventing the power supply unit from supplying power to at least the scan driver or the data driver.

15. The method of claim 12, wherein the data sensor includes a logic IC for sensing the shift signal period, the method further comprising:
inputting of the shift signal to the logic IC;
inputting of a RC unit voltages to the logic IC;
inputting of a clock signal to the logic IC; and
outputting of the control signal from the logic IC,
wherein the control signal pulse width of a control signal corresponding to one shift signal is proportional to values of a resistor and a capacitor forming the RC unit.

16. The method of claim 15, wherein the control signal is input to the data driver for preventing the data driver from driving the data lines.

17. The method of claim 15, wherein the control signal is input to the power supply unit for preventing the power supply unit from supplying power to the scan driver, or the data driver, or both.

18. The method of claim 15, wherein the logic IC comprises a monostable multivibrator.

19. The method of claim 16, wherein the control signal input to the data driver comprises a blanking signal.

20. The method of claim 17, wherein the control signal input to the power supply unit comprises an enable signal.
